(19) United States
(12) Patent Application Publication
(10) Pub. No.: US 2010/0244750 A1
(43) Pub. Date: Sep. 30, 2010

(54) HAND LANTERN

(76) Inventor: Wen-Sung Lee, Taichung City (TW)

Correspondence Address: Yen Jung Sung, 21-80 38 St, #C8, Astoria, NY, 11105, US

(21) Appl. No.: 12/413,534

(22) Filed: Mar. 28, 2009

(51) Int. Cl. H05B 37/02

(52) U.S. Cl. 315/362

(57) ABSTRACT

A hand lantern includes a base, a circuit unit received in the base, a touch switch unit received in the base and electrically connected to the circuit unit, a rechargeable unit received in the base and electrically connected to the circuit unit for providing electricity, a illuminating unit received in the base and electrically connected to the circuit unit, a lantern connected to the base and electrically connected to the touch switch, and a handle connected to the lantern to be adapted to be held by hand. When user touches the lantern, the touch switch unit sends a trigger signal to the circuit unit. When the circuit unit receives the trigger signal, the circuit unit sends a switch signal to the illuminating unit to switch on/off the illuminating unit.

### BACKGROUND OF THE INVENTION

1. Field of the Invention

The present invention relates to a lighting device, and more particularly to a portable hand lantern.

2. Description of Related Art

A conventional hand lantern in accordance with the prior art comprises a hand-held remote control transmitter and a remote control receiving triggering circuit installed within the lantern base. A trestle of the lantern base includes a light-source support and light-source socket. Fixed contacts are provided on both sides of the lower part of the light-source support. Mobile contacts corresponding to the fixed contacts are provided on both sides of the light-source socket. The fixed and mobile contacts form a contacting style circuit switch which serially connects a power-source to a remote control receiving triggering circuit. The output of the remote control receiving triggering circuit is connected to the light-source pin of the light-source socket.

The remote control transmitter is used in the conventional hand lantern to provide a remote control switch on-off functions. The remote control transmitter is limited by distance and always blocked by obstructions. When you hold the hand lantern in one hand, you need to hold the remote control transmitter in other hand to switch on/off the hand lantern. This is not convenient for user to operate the conventional hand lantern. Moreover, when you lose the remote control transmitter, you can not switch on/off the hand lantern. Furthermore, the light from the conventional hand lantern is strong. The strong light stimulates the eyes such that user feels tired easily; therefore the conventional hand lantern is not suitable for indoor use.

The present invention has arisen to mitigate and/or obviate the disadvantages of the conventional hand lantern.

### SUMMARY OF THE INVENTION

The main objective of the present invention is to provide an improved hand lantern, in that an easy-operated hand lantern suitable for indoor and outdoor use is acquired.

To achieve the objective, the hand lantern includes a base, a circuit unit received in the base, a touch switch unit received in the base and electrically connected to the circuit unit, a rechargeable unit received in the base and electrically connected to the circuit unit for providing electricity, a illuminating unit received in the base and electrically connected to the circuit unit, a lantern connected to the base and electrically connected to the touch switch, and a handle connected to the lantern to be adapted to be held by hand. When user touches the lantern, the touch switch unit sends a trigger signal to the circuit unit. When the circuit unit receives the trigger signal, the circuit unit sends a switch signal to the illuminating unit to switch on/off the illuminating unit. The lantern has multiple concaves formed therein for softening light from the illuminating unit.

In accordance with another aspect of the present invention, the hand lantern further includes an inner housing received in the lantern for isolating heat from the illuminating unit.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a hand lantern in accordance with the present invention;

FIG. 2 is an assembled perspective view of the hand lantern in accordance with the present invention, showing that a hand touches the lantern;

FIG. 3 is a front elevation cross-sectional view of the hand lantern in accordance with the present invention;

FIG. 3A is a partial enlarged cross-sectional view of the lantern of the hand lantern in FIG. 3;

FIG. 4 shows that the hand lantern in accordance with the present invention is placed outdoors;

FIG. 5 shows that the hand lantern in accordance with the present invention is placed indoors;

FIG. 6 is a perspective view of a second embodiment of a hand lantern in accordance with the present invention;

FIG. 6A is a partial enlarged cross-sectional view of the lantern of the hand lantern in FIG. 6; and

FIG. 7 is a perspective view of a third embodiment of a hand lantern in accordance with the present invention.

### DETAILED DESCRIPTION OF THE INVENTION

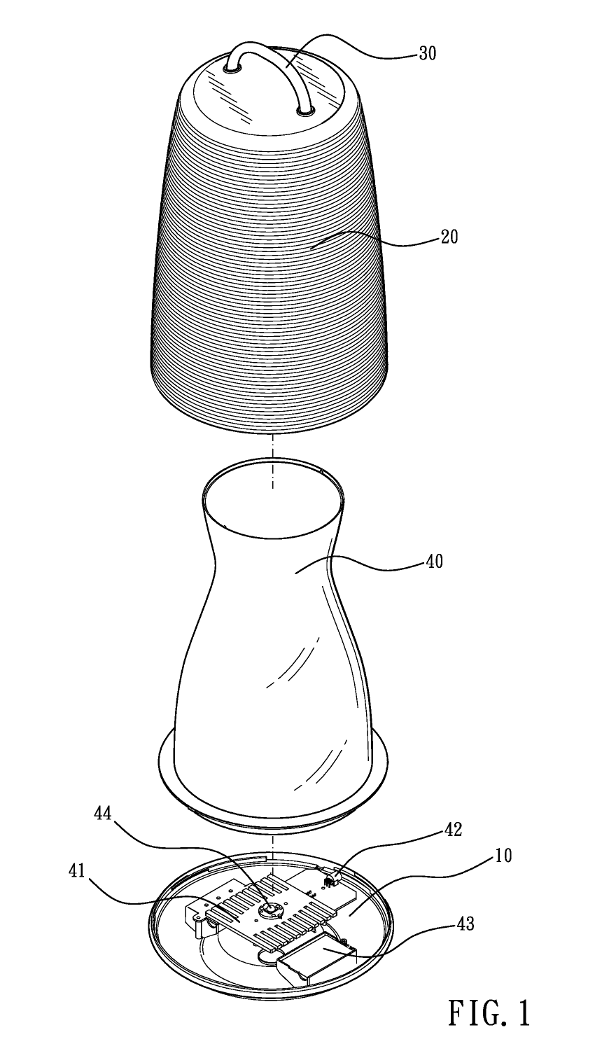

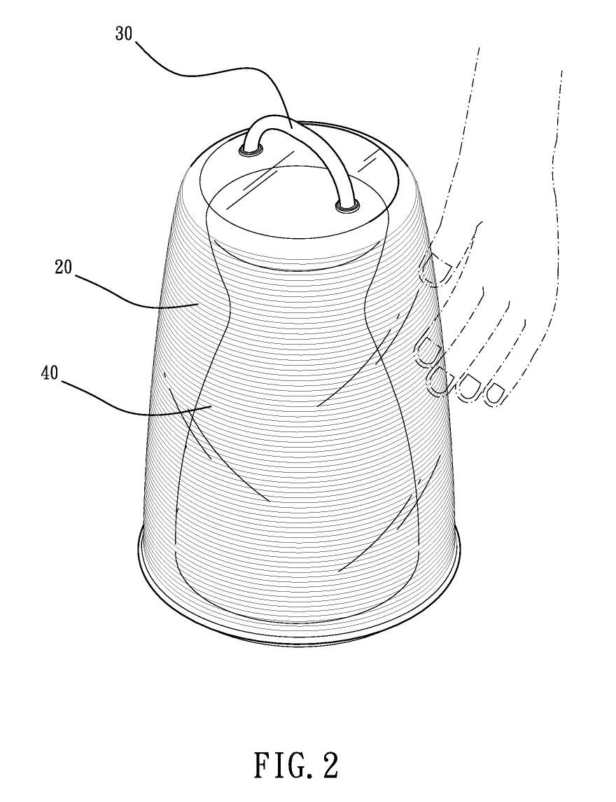

Referring to the drawings and initially to FIGS. 1-3, a hand lantern in accordance with the present invention comprises a base 10, a lantern 20 connected to the base 10, and a handle 30 connected to the lantern 20.

The hand lantern in accordance with the present invention further comprises a circuit unit 41 received in the base 10, a touch switch unit 42 electrically connected to the circuit unit 41, a rechargeable unit 43 electrically connected to the circuit unit 41, and a illuminating unit 44 electrically connected to the circuit unit 41. The rechargeable unit 43 is a rechargeable battery. When the circuit unit 41 is electrically connected to an outer power source (not shown), the circuit unit 41 sends a charging signal to the rechargeable unit 43 such that the rechargeable unit 43 starts to charge. When the circuit unit 41 is not electrically connected to the outer power source, the circuit unit 41 sends a discharging signal to the rechargeable unit 43 such that the rechargeable unit 43 discharges to provide electricity for the hand lantern. The illuminating unit 44 is a light emitting diode (LED) lamp. The touch switch unit 42 is a capacitance touch switch. The capacitance touch switch works using body capacitance, a property of the human body that gives it great electrical characteristics. The touch switch unit 42 is electrically connected to the lantern 20 to detect changes in capacitance. When user touches the lantern 20, it increases the capacitance and triggers the touch switch unit 42. The touch switch unit 42 sends a trigger signal to the circuit unit 41. When the circuit unit 41 receives the trigger signal, the circuit unit 41 sends a switch signal to switch on/off the illuminator unit 44. When the illuminator unit 44 is switched off, the circuit unit 41 sends the switch signal to switch on the illuminator unit 44. When the illuminator unit 44 is switched on, the circuit unit 41 sends the switch signal to switch off the illuminator unit 44.

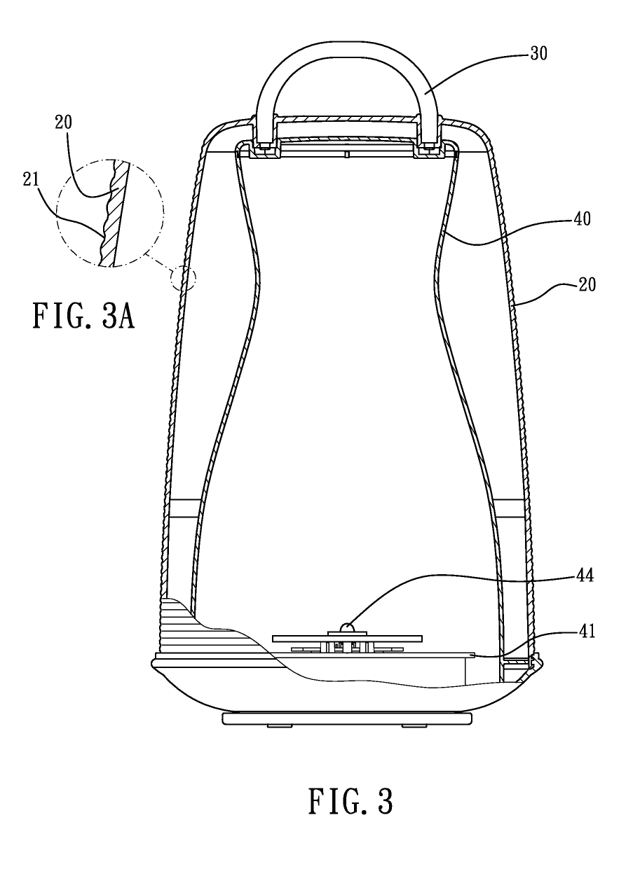

The lantern 20 is transparent and made of plastic or glass for passing the light from the illuminating unit 44. The lantern 20 has multiple concaves 21 formed in an outer surface thereof as shown in FIG. 3A. The multiple concaves 21 reflect the light such that the light is soft and wide. The hand lantern in accordance with the present invention lights up wider area than the conventional hand lantern.

The handle 30 is mounted on a top of the lantern 20. The handle 30 is made of plastic. The handle 30 is provided to be hold by user's hand.

The hand lantern in accordance with the present invention further comprises an inner housing 40 disposed between the lantern 20 and the base 10. The inner housing 40 is received in the lantern 20. The illuminating unit 44 generates huge heat, especially when the illuminating unit 44 is the high brightness LED lamp. The inner housing 40 is transparent and made of glass. The inner housing 40 is provided to isolate the heat to prevent user from burning by the lantern 20.

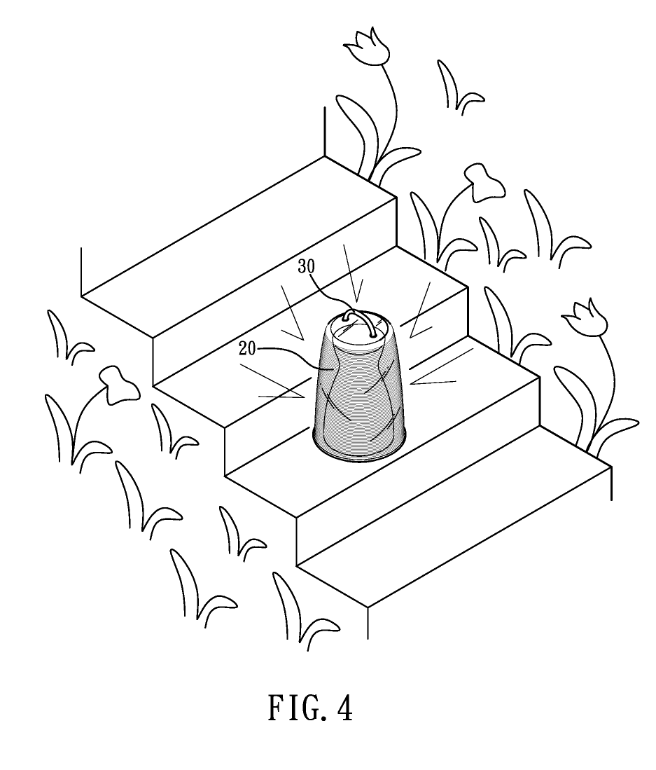

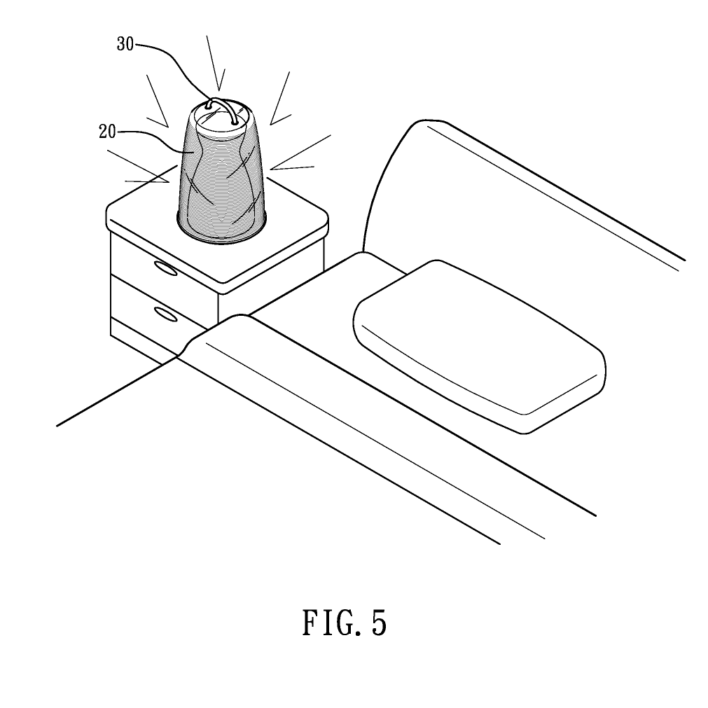

Referring to FIGS. 4 and 5, the operation of the hand lantern in accordance with the present invention is illustrated. The hand lantern in accordance with the present invention is used outdoors as shown in FIG. 4. User holds the handle 30 in one hand. When user wants to switch on the hand lantern, user touches the lantern 20 gently by the other hand to trigger the touch switch unit 42. The touch switch unit 42 sends the trigger signal to the circuit unit 42. The circuit unit 42 sends the switch signal to the illuminating unit 44 to switch on the illuminating unit 44. When user wants to switch off the lantern, user gently touches the lantern 20 again to trigger the touch switch unit 42. The touch switch unit 42 sends the trigger signal to the circuit unit 42. The circuit unit 42 sends the switch signal to the illuminating unit 44 to switch off the illuminating unit 44. Therefore, the operation of the hand lantern is easy and friendly. The light from the hand lantern is softened by the multiple concaves 21; therefore, the hand lantern is suitable for indoor use as shown in FIG. 5.

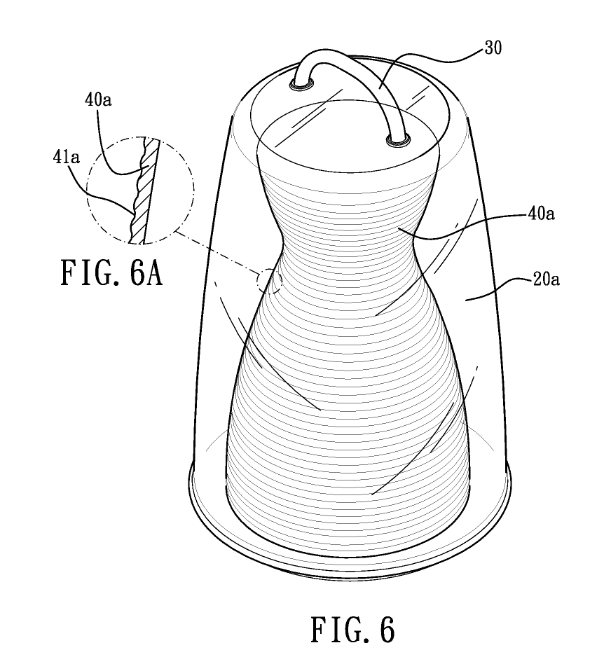

Referring to FIGS. 6 and 6A, a second embodiment of a hand lantern in accordance with the present invention is illustrated. The elements and the efforts which are the same with the first embodiment are not described, only the differences are described. The lantern 20a is transparent and made of glass or plastic. The inner housing 40a is transparent and made of glass. The inner housing 40a has multiple concaves 41a formed in an outer surface thereof for softening the light from the illuminating unit 44.

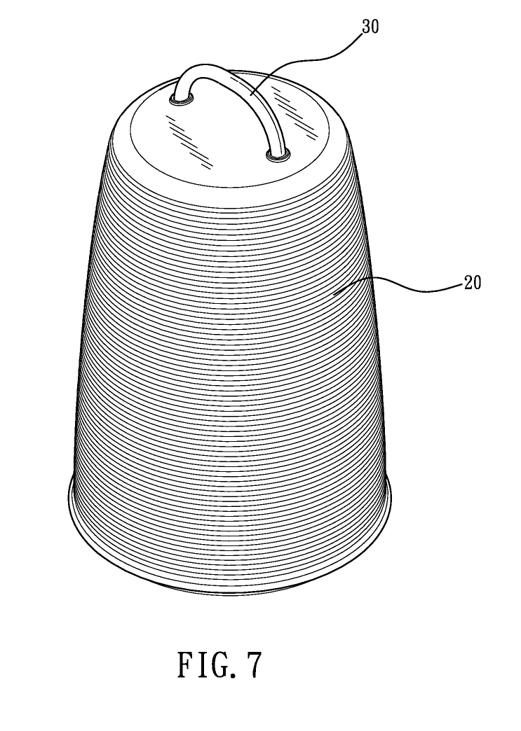

Referring to FIG. 7, a third embodiment of a hand lantern in accordance with the present invention is illustrated. The elements and the efforts which are the same with the first embodiment are not described, only the differences are described. In the third embodiment, the lantern 20 is made of glass. Compare to the first and third embodiment, there is no inner housing 40 in the third embodiment.

Although the invention has been explained in relation to its preferred embodiment, it is to be understood that many other possible modifications and variations can be made without departing from the spirit and scope of the invention as hereinafter claimed.

What is claimed is:

1. A hand lantern comprising:
a base;
a circuit unit received in the base;
a touch switch unit received in the base and electrically connected to the circuit unit;
a rechargeable unit received in the base and electrically connected to the circuit unit for providing electricity;
a illuminating unit received in the base and electrically connected to the circuit unit;
a lantern connected to the base and electrically connected to the touch switch; and
a handle connected to the lantern to be adapted to be held by hand;
wherein when user touches the lantern, the touch switch unit sends a trigger signal to the circuit unit; when the circuit unit receives the trigger signal, the circuit unit sends a switch signal to illuminating unit to switch on/off the illuminating unit.

2. The hand lantern as claimed in claim 1, wherein the lantern has multiple concaves formed therein for softening light from the illuminating unit.

3. The hand lantern as claimed in claim 1, wherein the illuminating unit is a LED lamp.

4. The hand lantern as claimed in claim 1, wherein the rechargeable unit is a rechargeable battery.

5. The hand lantern as claimed in claim 1, wherein the touch switch unit is a capacitance touch switch.

6. The hand lantern as claimed in claim 1, wherein the lantern is transparent and made of glass.

7. The hand lantern as claimed in claim 1 further comprising an inner housing received in the lantern for isolating heat from the illuminating unit.

8. The hand lantern as claimed in claim 7, wherein the inner housing having multiple concaves formed therein for softening light from the illuminating unit.

9. The hand lantern as claimed in claim 8, wherein the inner housing is transparent and made of glass.

10. The hand lantern as claimed in claim 7, wherein the inner housing is transparent and made of glass.
